(19) United States
(12) Patent Application Publication
(10) Pub. No.: US 2019/0158893 A1
(43) Pub. Date: May 23, 2019

(54) Video Content Integration System and Method Thereof

(71) Applicant: VAS Creative Co., Ltd., Taipei City 115 (TW)

(72) Inventor: Tien-Ming Wang, Taipei City (TW)

(21) Appl. No.: 15/905,980

(22) Filed: Feb. 27, 2018

(30) Foreign Application Priority Data
Nov. 23, 2017 (TW) 106140833

(51) Int. Cl. H04N 21/2343; H04N 21/84; H04N 19/46; H04N 21/4402

(52) U.S. Cl. CPC H04N 21/2343; H04N 21/44029; H04N 19/46; H04N 21/84

(57) ABSTRACT

A video content integration system and method for converting an original video to a customized product video based on customer requirements thereof are disclosed. The original video has a first video file. The video content integration system has a video file receiving module, a customer requirement instruction generating module, a metadata information gathering module, a video code compressing module and a content integration module. The video file receiving module receives the original video. The customer requirement instruction generating module generates a requirement instruction based on customer requirements. The metadata information gathering module gathers metadata information related to the original video according to the requirement instruction. The video code compressing module compresses the first video file to a second video file according to the requirement instruction. The second video file and metadata information are integrated into the customized product video by the content integration module.

### BACKGROUND OF THE INVENTION

### 1. Field of the Invention

The present invention relates to a video content integration system and a video content integration method; more particularly, the present invention relates to a video content integration system and a video content integration method capable of providing a customized product video based on customer requirements.

### 2. Description of the Related Art

Nowadays, a variety of video playback platforms are available for consumers to use. However, because there is no standardized interface for video playback, each of the video playback platforms has different requirements, and specifications for receiving and normally playing back video products on mobile phones, tablet computers or TV monitors are varied. This variety causes much complexity in a file conversion and integration procedure to a video product supplier.

Therefore, there is a need to provide a video content integration system and a method thereof to mitigate and/or obviate the aforementioned problems.

### SUMMARY OF THE INVENTION

It is an object of the present invention to provide a video content integration system capable of providing a customized product video based on customer requirements.

It is another object of the present invention to provide a video content integration method capable of providing a customized product video based on customer requirements.

To achieve the abovementioned objects, the video content integration system of the present invention is used for converting an original video to a customized product video based on customer requirements, wherein the original video has a first video file. The video content integration system comprises a video file receiving module, a customer requirement instruction generating module, a metadata information gathering module, a video code compressing module and a content integration module. The video file receiving module is used for receiving the original video. The customer requirement instruction generating module is used for generating a requirement instruction based on the customer requirements. The metadata information gathering module is used for gathering metadata information related to the original video according to the requirement instruction. The video code compressing module is used for compressing the first video file into a second video file according to the requirement instruction, wherein the second video file is a digital video file. The content integration module is used for integrating the second video file and the metadata information into the customized product video.

The present invention further provides a video content integration method for converting an original video to a customized product video based on customer requirements, wherein the original video has a first video file. The video content integration method comprises the following steps: receiving the original video via a video file receiving module; generating a requirement instruction based on the customer requirements via a customer requirement instruction generating module; compressing the first video file into a second video file via a video code compressing module, wherein the second video file is a digital video file; gathering metadata information related to the original video according to the requirement instruction, via a metadata information gathering module; and integrating the second video file and the metadata information into the customized product video via a content integration module.

The present invention is characterized in that the video content integration system and the video content integration method of the present invention can convert an original video into a video format requested by a customer based on customer requirements, and can combine related metadata information required by the customer so as to provide a customized product video which satisfies requirements for different video playback platforms.

Other objects, advantages, and novel features of the invention will become more apparent from the following detailed description when taken in conjunction with the accompanying drawings.

### BRIEF DESCRIPTION OF THE DRAWINGS

The objects and advantages of the present invention will become apparent from the following description of the accompanying drawings, which disclose several embodiments of the present invention. It is to be understood that the drawings are to be used for purposes of illustration only, and not as a definition of the invention.

In the drawings, wherein similar reference numerals denote similar elements throughout the several views:

FIG 1 illustrates a hardware structure and application environment schematic drawing of a video content integration system according to one embodiment of the present invention.

FIG. 2 illustrates a hardware structure schematic drawing of the video content integration system according to one embodiment of the present invention.

FIG. 3 illustrates a flowchart of a video content integration method according to a first embodiment of the present invention.

FIG. 4 illustrates a flowchart of the video content integration method according to a second embodiment of the present invention.

### DETAILED DESCRIPTION OF THE PREFERRED EMBODIMENT

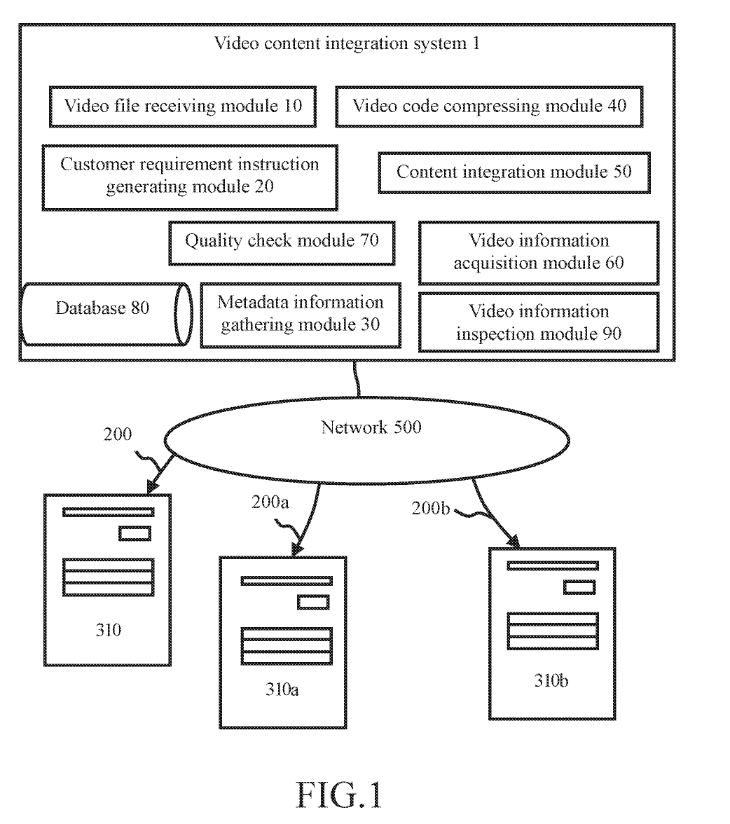

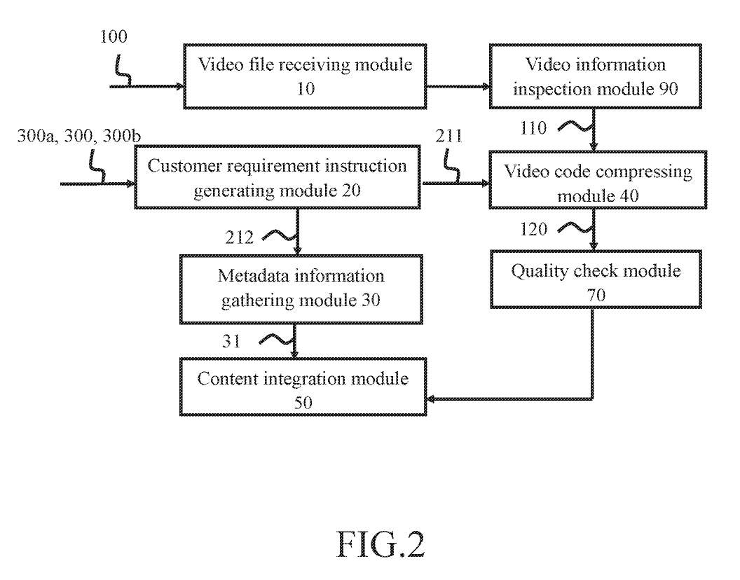

Please refer to FIG. 1 and FIG. 2, which illustrate hardware structure and application environment schematic drawings of a video content integration system according to one embodiment of the present invention.

As shown in FIG. 1 and FIG. 2, the video content integration system 1 of the present invention is, for example, one or multiple computer servers. The video content integration system 1 of the present invention can convert an original video 100 to a customized product video 200, 200a, 200b based on customer requirements 300, 300a, 300b. According to one embodiment of the present invention, the video content integration system 1 transmits the customized product videos 200, 200a, 200b to video playback platforms 310, 310a, 310b via a network 500, respectively.

As shown in FIG. 1 and FIG. 2, the video content integration system 1 of the present invention comprises a video file receiving module 10, a customer requirement instruction generating module 20, a metadata information gathering module 30, a video code compressing module 40, a content integration module 50, a video information acquisition module 60, a quality check module 70, a database 80 and a video information inspection module 90. The video file receiving module 10 receives the original video 100 provided by a provider. The original video 100 comprises a first video file 110 and video information. The video information includes a title and duration information. The first video file 110 can be in the formats of WMV, AVI, MPEG, RMVB or RM, and the provider can be a film maker, a person or a company.

As shown in FIG. 1 and FIG. 2, after the video content integration system 1 of the present invention receives the original video 100, the video information inspection module 90 inspects whether the first video file 110 is damaged or incomplete so as to evaluate whether the first video file 110 can be compressed and converted. If the first video file 110 is damaged or incomplete, the video content integration system 1 of the present invention will request that provider of the original video 100 re-provide the original video 100. If the first video file 110 is neither damaged nor incomplete, the first video file 110 can be compressed and converted. Moreover, the video content integration system 1 of the present invention can further acquire the video information via the video information acquisition module 60. The video information includes a title so that the metadata information gathering module 30 can search for information related to the title from the Internet, such as information of the actor/actress in the leading role, its duration, or the director.

The customer requirement instruction generating module 20 generates requirement instructions based on the customer requirements 300, 300a, 300b so as to convert the original video 100 to the customized product video 200, 200a, 200b based on the customer requirements 300, 300a, 300b. According to one embodiment of the present invention, the requirement instruction comprises a file conversion format requirement 211 and a metadata information requirement 212. The customer requirement instruction generating module 20 transmits the file conversion format requirement 211 to the video code compressing module 40, and transmits the metadata information requirement 212 to the metadata information gathering module 30. Please note that in this embodiment, the customer requirements 300, 300a or 300b can be, but are not limited to, requirements assigned by the provider of the original video 100. The customer requirements 300, 300a or 300b can also be designed according to specifications of the video playback platforms 310, 310a, 310b.

The metadata information gathering module 30 receives the metadata information requirement 212 from the customer requirement instruction generating module 20 and gathers metadata information 31 related to the original video 100 according to the metadata information requirement 212. According to one embodiment of the present invention, the metadata information gathering module 30 utilizes a crawler program to gather information related to the original video 100 from the Internet according to the metadata information requirement 212, such as interviews with actors/actresses, behind-the-scenes stories, trailers or related news information. For example, if the metadata information requirement 212 requires interviews with actors/actresses and trailers related to the original video 100, the metadata information gathering module 30 will accordingly gather interviews with actors/actresses and trailers elated to the original video 100 as the metadata information 31. Please note that the metadata information requirement 212 might also include video copyright and licensing requirements.

The video code compressing module 40 receives the file conversion format requirement 211 from the customer requirement instruction generating module 20 and compresses the first video file 110 into a second video file 120 according to the file conversion format requirement 211. The second video file 120 is a digital video file and can be in the formats of WMV, FLV, MPEG-4, image files, RM, MOV, DivX, and the like. The file conversion format requirement 211 can comprise a resolution requirement and a file type requirement. For example, if the file conversion format requirement 211 requires conversion of the first video file 110 into a Full HD MPEG-4 format, the video code compressing module 40 will then convert the first video file 110 into the second video file 120 in the format of Full HD MPEG-4. Meanwhile, the quality check module 70 will check the compression quality of the second video file 120. If the compression quality of the second video file 120 is insufficient, the video code compressing module 40 will need to re-compress the first video file 110. As shown in FIG. 1 and FIG. 2, after the second video file 120 is completely converted and passes the quality check of the quality check module 70, the content integration module 50 is used for integrating the second video file 120 and the metadata information 31 into the customized product video 200, and a transmission module will transmit the customized product video 200 to a specific video playback platform 310, 310a or 310b, and the database 80 will be stored with the original video 100, the first video file 110, the second video file 120, the metadata information 31 and the customized product video 200.

Please note that each of the abovementioned modules can be configured as a hardware device, a software program, a firmware or a combination thereof, and can also be configured as a circuit loop or other appropriate forms without limiting the scope of the present invention. Furthermore, each module can be configured independently or combined with other modules. According to one preferred embodiment of the present invention, each of the modules is a software program stored in a memory for being executed by a processor (not shown in figures) of the video content integration system 1 to achieve the objects of the present invention. Moreover, the abovementioned embodiments are only preferred embodiments for explaining the present invention; to avoid repetition, not all possible variations and combinations are described in detail in this specification. However, it should be understood by those skilled in the art that each of the abovementioned modules or components is not essential. Furthermore, to implement the present invention, other known modules or components might also be included. Each module or component can be omitted or altered according to different requirements, and it is possible to provide other modules or components between any two modules.

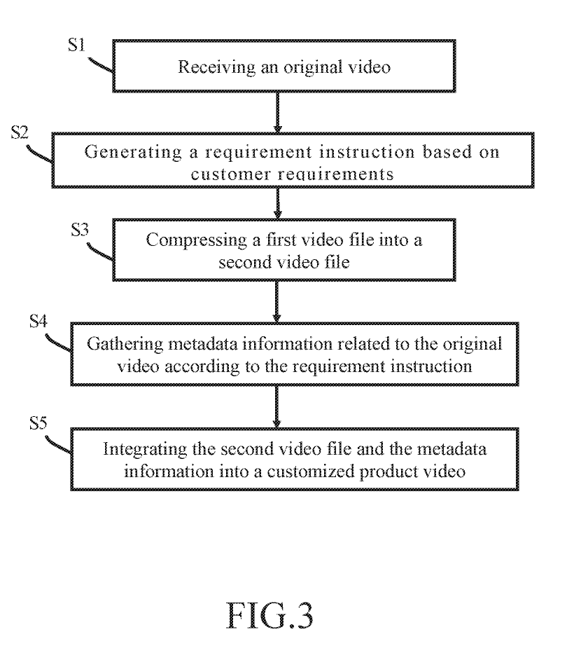

Please refer to FIG. 1, FIG. 2 and FIG. 3. FIG. 3 illustrates a flowchart of the video content integration method according to a first embodiment of the present invention.

As shown in FIG. 1 and FIG. 2, the video content integration method of the present invention is used for converting an original video 100 to a customized product video 200 based on customer requirements. The original video 100 comprises a first video file 110 and video information. As shown in FIG. 3, the video content integration method of the present invention mainly comprises steps S1 to S5. Each of the steps of the video content integration method according to the first embodiment of the present invention will be described in detail hereinafter.

Step S1: Receiving an Original Video.

The video file receiving module 10 receives the original video 100 provided by a provider. The original video 100 comprises a first video file 110 and video information. The video information includes a title and duration information. The first video file 110 can be in the formats of WMV, AVI, MPEG, RMVB or RM, and the provider can be a film maker, a person or a company.

Step S2: Generating a Requirement Instruction Based on Customer Requirements.

The customer requirement instruction generating module 20 generates requirement instructions based on the customer requirements 300, 300a, 300b so as to convert the original video 100 to the customized product video 200, 200a, 200b based on the customer requirements 300, 300a, 300b. According to one embodiment of the present invention, the requirement instruction comprises a file conversion format requirement 211 and a metadata information requirement 212. The customer requirement instruction generating module 20 transmits the file conversion format requirement 211 to the video code compressing module 40, and transmits the metadata information requirement 212 to the metadata information gathering module 30. The file conversion format requirement 211 might comprise a resolution requirement and a file type requirement. For example, the file conversion format requirement 211 might require the conversion of the first video file 110 into a Full HD MPEG-4 format, and the metadata information requirement 212 might require interviews with actors/actresses and trailers related to the original video 100. In this embodiment, the customer requirements 300, 300a or 300b can be, but are not limited to, requirements assigned by the provider of the original video 100. The customer requirements 300, 300a or 300b can also be designed according to specifications of the video playback platforms 310, 310a, 310b.

Step S3: Compressing a First Video File Into a Second Video File.

In this embodiment, the file conversion format requirement 211 converts the first video file 110 into, for example, a Full HD MPEG-4 format, so the video code compressing module 40 will accordingly convert the first video file 110 into a second video file 120 in the format of Full HD MPEG-4. The second video file 120 of the present invention is a digital video file and can be in the formats of WMV, FLV, MPEG-4, image files, RM, MOV, DivX, and the like.

Step S4: Gathering Metadata Information Related to the Original Video According to the Requirement Instruction.

In this embodiment, if the metadata information requirement 212 requires, for example, interviews with actors/actresses and trailers related to the original video 100, the metadata information gathering module 30 will accordingly gather interviews with actors/actresses and trailers related to the original video 100 as the metadata information 31. Please note that the metadata information requirement 212 might also include video copyright and licensing requirements.

Step 55: Integrating the Second Video File and the Metadata Information Into a Customized Product Video.

The content integration module 50 is used for integrating the second video file 120 and the metadata information 31 into the customized product video 200 so that a transmission module can transmit the customized product video 200 to a specific video playback platform 310, 310a or 310b.

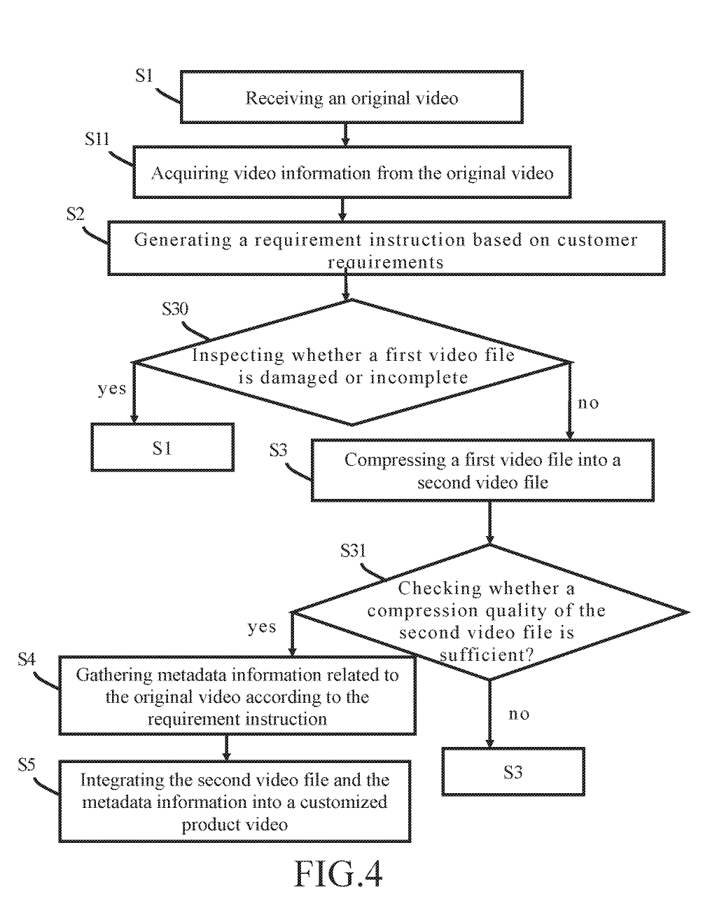

Please refer to FIG. 1, FIG. 2 and FIG. 4. FIG. 4 illustrates a flowchart of the video content integration method according to a second embodiment of the present invention. As shown in FIG. 4, the difference between the second embodiment and the first embodiment of the video content integration method of the present invention is that, in the second embodiment, the video content integration method of the present invention further comprises steps S11, S30 and S31. Steps S11, S30 and S31 will be described in detail hereinafter.

Step S11: Acquiring Video Information From the Original Video.

The video information acquisition module 60 acquires the video information. The video information includes a title so that the metadata information gathering module 30 of the video content integration system 1 can search for information related to the title from the Internet, such as information of the actor/actress in the leading role, its duration, or the director.

Step S30: Inspecting Whether a First Video File is Damaged or Incomplete

After the video content integration system 1 receives the original video 100, the video information inspection module 90 inspects whether the first video file 110 is damaged or incomplete so as to evaluate whether the first video file 110 can be compressed and converted. If the first video file 110 is damaged or incomplete, the provider of the original video 100 is requested to re-provide the original video 100 by returning to step S1. If the first video file 110 is neither damaged nor incomplete, the first video file 110 can be compressed and converted by advancing to step S3.

Step S31: Checking Whether a Compression Quality of the Second Video File is Sufficient

The quality check module 70 is utilized to check the compression quality of the second video file 120. If the compression quality of the second video file 120 is not sufficient, the video code compressing module 40 needs to perform re-compression by returning to step S3. As shown in FIG. 1 and FIG. 2, after the second video file 120 is completely converted and passes the check of the quality check module 70, the method performs step S4 and step S5 by using the content integration module 50 to integrate the second video file 120 and the metadata information 31 into the customized product video 200 and using a transmission module to transmit the customized product video 200 to a specific video playback platform 310, 310a or 310b. The database 80 is stored with the original video 100, the first video file 110, the second video file 120, the metadata information 31 and the customized product video 200.

The video content integration system 1 and the video content integration method of the present invention can convert the original video 100 into a video format as requested by a customer based on customer requirements 300, 300a, 300b, and can combine related information required by the customer so as to provide customized product videos 200, 200a, 200b which satisfy the requirements for the different video playback platforms 310, 310a, 310b.

Although the present invention has been explained in relation to its preferred embodiments, it is to be understood that many other possible modifications and variations can be made without departing from the spirit and scope of the invention as hereinafter claimed.

What is claimed is:

1. A video content integration system, used for converting an original video to a customized product video based on customer requirements, wherein the original video has a first video file, the video content integration system comprising:
a video file receiving module for receiving the original video;
a customer requirement instruction generating module for generating a requirement instruction based on the customer requirements;
a metadata information gathering module for receiving the requirement instruction from the customer requirement instruction generating module, and for gathering metadata information related to the original video according to the requirement instruction;
a video code compressing module for receiving the requirement instruction from the customer requirement instruction generating module, and for compressing the first video file into a second video file according to the requirement instruction, wherein the second video file is a digital video file; and
a content integration module for integrating the second video file and the metadata information into the customized product video.

2. The video content system as claimed in claim 1, further comprising a video information inspection module, wherein the video information inspection module inspects whether the first video file is damaged or incomplete.

3. The video content integration system as claimed in claim 1, wherein the requirement instruction comprises a file conversion format requirement and a metadata information requirement.

4. The video content system as claimed in claim 3, further comprising a video information inspection module, wherein the video information inspection module inspects whether the first video file is damaged or incomplete.

5. The video content integration system as claimed in claim 1, further comprising a quality check module, electrically connected to the video code compressing module, used for checking a compression quality of the second video

6. The video content system as claimed in claim 5, further comprising a video information inspection module, wherein the video information inspection module inspects whether the first video file is damaged or incomplete.

7. The video content integration system as claimed in claim 1, further comprising a database for storing the original video, the first video file, the second video file, the metadata information and the customized product video.

8. The video content system as claimed in claim 7, further comprising a video information inspection module, wherein the video information inspection module inspects whether the first video file is damaged or incomplete.

9. The video content integration system as claimed in claim 1, wherein the original video comprises video information, the video information includes a title and duration information, and the video content integration system has a video information acquisition module to acquire the video information, where the video information includes a title.

10. The video content system as claimed in claim 9, further comprising a video information inspection module, wherein the video information inspection module inspects whether the first video file is damaged or incomplete.

11. A video content integration method, used for converting an original video to a customized product video based on customer requirements, wherein the original video has a first video file, and the video content integration method comprises the following steps:
receiving the original video via a video file receiving module;
generating a requirement instruction based on the customer requirements via a customer requirement instruction generating module;
compressing the first video file into a second video file via a video code compressing module, wherein the second video file is a digital video file;
gathering metadata information related to the original video according to the requirement instruction via a metadata information gathering module; and
integrating the second video file and the metadata information into the customized product video via a content integration module.

12. The video content integration method as claimed in claim 11 further comprising the following step prior to the step of integrating the second video file and the metadata information into the customized product video via the content integration module:
checking a compression quality of the second video file via a quality check module.

13. The video content integration method as claimed in claim 12, further comprising the following steps prior to the step of compressing the first video file into the second video file via the video code compressing module:
inspecting whether the first video file is damaged or incomplete via a video information inspection module; and
acquiring video information from the original video, where the video information includes a title, via a video information acquisition module.

14. The video content integration method as claimed in claim 11, wherein the requirement instruction comprises a file conversion format requirement and a metadata information requirement.

15. The video content integration method as claimed in claim 14, further comprising the following step prior to the step of integrating the second video file and the metadata information into the customized product video via the content integration module:
checking a compression quality of the second video file via a quality check module.

16. The video content integration method as claimed in claim 15, further comprising the following steps prior to the step of compressing the first video file into the second video file via the video code compressing module:
inspecting whether the first video file is damaged or incomplete via a video information inspection module; and
acquiring video information from the original video, wherein the video information includes a title, via a video information acquisition module.
